(19) United States
(12) Patent Application Publication
(10) Pub. No.: US 2009/0138290 A1
(43) Pub. Date: May 28, 2009

(54) INSURANCE ADJUSTMENT THROUGH DIGITAL IMAGING SYSTEM AND METHOD

(76) Inventor: Johnny L. Holden, Seattle, WA (US)

Correspondence Address: AXIOS LAW GROUP. PLLC, 1525 4TH AVE, STE 800, SEATTLE, WA, 98101-1648, US

(21) Appl. No.: 11/858,814

(22) Filed: Sep. 20, 2007

Related U.S. Application Data
(60) Provisional application No. 60/827,025, filed on Sep. 26, 2006.

(51) Int. Cl. G06Q 40/00

(52) U.S. Cl. 705/4

(57) ABSTRACT

This invention relates generally to insurance adjusting and damage appraisal, and more specifically, to systems and methods for insurance adjustment and damage appraisal through digital imaging. In one embodiment, the invention includes a method for providing an insurance adjustment or damage appraisal, which includes the steps of a user generating an image of a damaged vehicle, sending the image to an image processing center, comparing the image to an image of a similar undamaged vehicle, which is stored in a database, and generating a damage appraisal or insurance adjustment based on differences in the depicted vehicles.

### RELATED REFERENCES

This application claims priority to U.S. Provisional Application 60/827,025 filed Sep. 26, 2006. The foregoing application is hereby incorporated by reference in its entirety as if fully set forth herein.

### FIELD

This invention relates generally to insurance adjusting and damage appraisal, and more specifically, to systems and methods for insurance adjustment and damage appraisal through digital imaging.

### BACKGROUND

Insurance has existed in one form or another since 2000 BCE, when the Babylonians recorded an insurance system in the Code of Hammurabi, which allowed Mediterranean sailing merchants to pay an additional sum to a lender in exchange for the lender's guarantee to cancel the loan if a shipment of goods was stolen. Today many types of insurance exist, including automobile, boiler, casualty, credit, health, and liability insurance.

For automobile insurance, a common type of plan can include liability and collision insurance, which pays for some or all of the cost associated with damage caused to the policy holder's vehicle or damaged caused to another vehicle by the policy holder. Commonly, when an accident occurs a policy holder must file a claim with their insurance company, who must then assess any damage made to one or more vehicle, including the policy holder's vehicle. Commonly, an insurance adjuster, damage appraiser, or mechanic must view a damaged vehicle and make an estimation of the damage, which can be expensive to an insurance company and therefore expensive to the insurance company's policy holders.

Damage appraisals are often expensive and time consuming because a person usually physically inspects a damaged vehicle or inspects pictures of a damaged vehicle. Insurance adjusters, damage appraisers, and mechanics may have a heavy work-load and it can sometimes take a few days or more before a damage estimation can be made. Policy holders who make insurance claims want their claims to be handled as quickly as possible and want any damage to their vehicles repaired as quickly as possible; especially if a vehicle has been disabled and cannot be driven. Additionally, policy holders do not appreciate having to pay higher insurance premiums associated with having an expensive damage assessment performed for each vehicle.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices that facilitate insurance adjustment and damage appraisal through digital imaging in accordance with an embodiment of the invention.

FIG. 2 is a block diagram of a device that provides an exemplary operating environment for various embodiments.

FIG. 3 is a diagram of the actions taken by devices during insurance adjustment and damage appraisal through digital imaging in accordance with an embodiment of the invention.

FIG. 4 is a flow diagram illustrating a routine for insurance adjustment and damage appraisal through digital imaging in accordance with an embodiment of the invention.

FIG. 5 is a side view image of an undamaged vehicle, which has been placed onto a grid system, in accordance with an embodiment of the invention.

FIG. 6 is a side view image of a damaged vehicle, which has been placed onto a grid system, in accordance with an embodiment of the invention.

FIG. 7 is a close-up side view image of an undamaged vehicle, which has been placed onto a grid system, in accordance with an embodiment of the invention.

FIG. 8 is a close-up side view image of a damaged vehicle, which has been placed onto a grid system, in accordance with an embodiment of the invention.

FIG. 9 is a front view image of an undamaged vehicle, which has been placed onto a grid system, in accordance with an embodiment of the invention.

FIG. 10 is a front view image of a damaged vehicle, which has been placed onto a grid system, in accordance with an embodiment of the invention.

FIG. 11 is a flow diagram illustrating a subroutine for estimating damage to a vehicle, in accordance with an embodiment of the invention.

FIG. 12 is a flow diagram illustrating a subroutine for estimating damage to a vehicle, in accordance with a further embodiment of the invention.

FIG. 13 is a flow diagram illustrating a subroutine for calculating a damage estimate, in accordance with a still further embodiment of the invention.

### DESCRIPTION

Illustrative embodiments presented herein include, but are not limited to, systems and methods for insurance adjustment and damage appraisal through digital imaging.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

As described herein, the term “imaging,” and the like, refers to the act or process of making images, animations, three-dimensional graphics, other spatial representation of any physical or theoretical object, space, plain, area, or configuration of matter, and the like. Imaging includes, but is not limited to the act or method of creating images through the capture of or exposure to, matter or energy, including radio waves, light waves, infrared waves, x-rays, gamma rays, heat waves, and the like. As described herein, digital imaging refers to the act or process of creating digital images, and such act or process can comprise the processing, compression, editing, storage, printing, display, presentation of digital images, and the like. Digital imaging or photography can utilize, among other things, a digital camera, digital camera back, cellular telephone, digital video recorder, personal data assistant, webcam, personal computer, laptop computer, and the like.

As described herein, the phrase “non-digital imaging,” and the like refers to the act or process of creating non-digital images, and such act or process can comprise the processing, editing, storage, printing, display, presentation of non-digital images, and the like. Non-digital imaging includes, but is not limited to, the act or process of making images, animations, three-dimensional graphics, or other spatial representation of any physical or theoretical object, space, plain, area, or configuration of matter by mechanical or chemical means or both mechanical and chemical means, and the like. Non-digital imaging or photography can utilize, among other things, any type of camera including, pinhole, rangefinder, twin-lens, view cameras, movie camera, stereo camera, and the like; additionally, non-digital imaging can utilize, among other things, photographic film, photographic plate, or photographic paper, and the like.

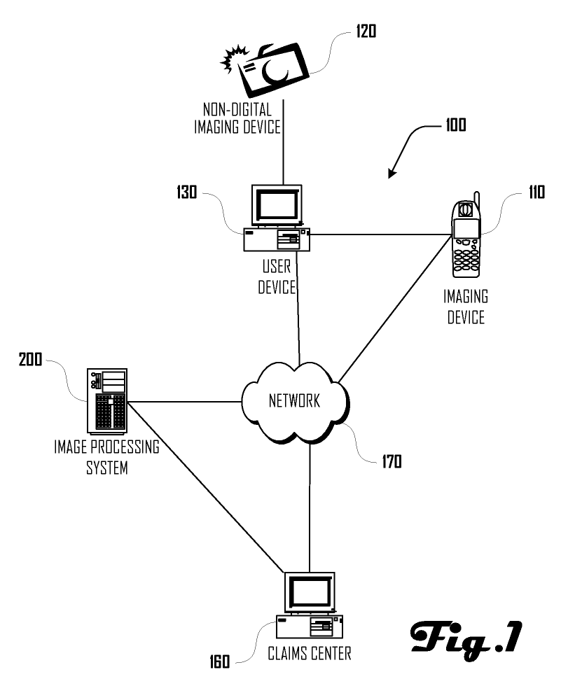

FIG. 1 is a pictorial diagram of a system of interconnected devices that facilitate insurance adjustment and damage appraisal through digital imaging 100 in accordance with an embodiment of the invention. FIG. 1 depicts a digital imaging device 110 and a non-digital imaging device 120, both of which are operationally connected or associated with a user device 130. Additionally, the user device 130, the digital imaging device 110, an imaging processing system 150 and a claims center 160 are operationally connected via a network 170. In one embodiment, as depicted here, the image processing system 200 can be operationally connected to the claims center 160 directly.

For purposes of illustration only, the digital imaging device 110 is depicted here as a cellular telephone that comprises a digital camera, however, the digital imaging device 110, can be any system or device that is capable of digital imaging. Additionally, for purposes of illustration only the non-digital imaging device 120 is depicted as a camera that utilizes photographic film, however, the non-digital imaging device 120 can be any system or device that is capable of non-digital imaging. In one embodiment, the digital imaging device 110 is a cellular telephone, a personal data assistant, a digital camera, or the like.

Both the digital imaging device 110 and the non-digital imaging device 120 can be operationally connected or associated with a user device 130. In one embodiment, the digital imaging device 110 is operationally connected with the user device 130 through a cable, or network including, but not limited to D-subminiature, edgecard, centronics, USB, FireWire, BNC, RJ-11, wireless network, the Internet, local area network, or the like. In a further embodiment, the non-digital imaging device 120 is operationally connected or associated with the user device 130 through optical scanning of photographic prints or negatives via a digital scanner. (e.g. a digital imaging device, such as imaging device 110). In a still further embodiment, the digital imaging device 110, the non-digital imaging device 120, and the user device 130 can be in a disparate, close, similar, or proximate locations compared to each other.

The user device 130 can be configured to receive and send digital images and otherwise be operationally connected to the digital imaging device 110, and the image processing system 200. The image processing system 200 can be a computing device. Computing devices are well known in the art and one reasonably skilled in the art will immediately appreciate the many systems that may comprise a computing device, including, but not limited to monitor, a hard drive, random access memory, a motherboard, a chipset, a keyboard, a CD-Rom, a scanner, a printer, a database, software, an internet or network card, or a wireless card. In one embodiment the user device 130 can be configured to edit, manipulate, and configure digital images. In one embodiment, the user device 130 can upload or communicate digital images to the image processing system 200 through a website. In another embodiment, the user device 130 can send digital images to the image processing system 200 through electronic mail or e-mail.

The image processing system 200 is capable of receiving digital images, or any other type of image, processing or analyzing the image, and providing an insurance adjustment or damage appraisal based on a given image. The image processing system 200 is operationally connected with the claims center 160 via a network 170 and can communicate an insurance adjustment or damage appraisal that has been generated by the image processing system 200. The image processing system 200 can be a computing device as described herein. The claims center 160 can comprise one or more insurance adjuster, damage appraiser, or other employee, agent or assign or an insurance company. Additionally, the claims center 160 can comprise one or more computing device, which can be configured to be in operationally connected with the image processing system 200. In another embodiment, the image processing system 200 can be in a disparate, close, similar, same or proximate location compared to the claims center 160.

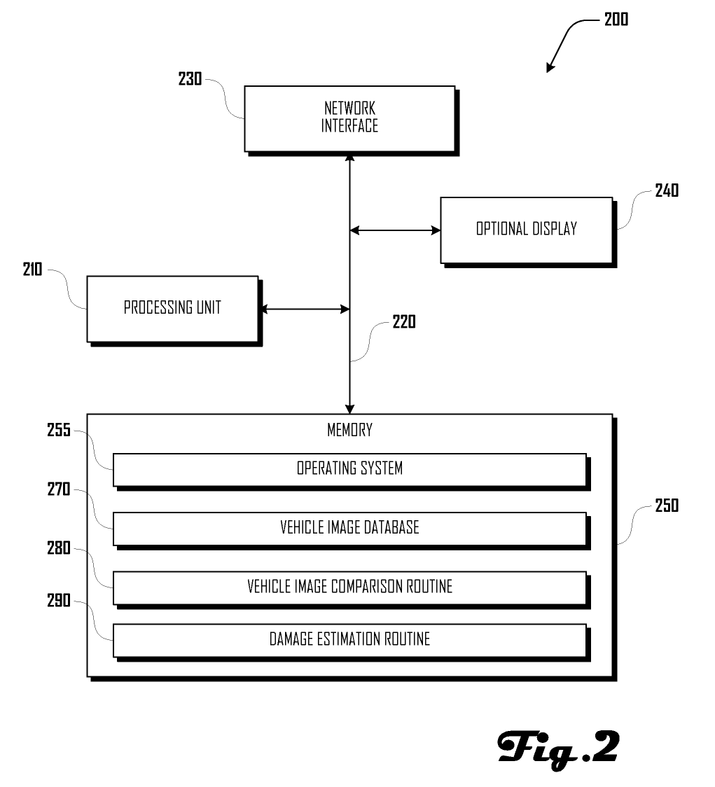

FIG. 2 illustrates several components of an exemplary operating environment 200 for an embodiment. For example, the user device 130, the image processing system 120, or the claims center 160 can be embodied in the operating environment 200 depicted in FIG. 2. Those of ordinary skill in the art and others will appreciate that the operating environment 200 may include many more components than those shown in FIG. 2. However, it is not necessary that all of these generally conventional components be shown in order to disclose an enabling embodiment for practicing the embodiments described herein. As shown in FIG. 2, the operating environment 200 includes a network interface 230 for connecting to remote devices (not shown). The network interface 230 may be a network interface designed to support a local area network (“LAN”), wireless local area network (“WLAN”), personal area network (“PAN”), telephone network, powerline connection, serial bus, universal serial bus (“USB”) wireless connection, or the like. The network interface 230 includes the necessary circuitry, driver and/or transceiver for such a connection and is constructed for use with the appropriate protocols for such a connection.

The operating environment 200 also includes a processing unit 210, an optional display 240 and a memory 250, all interconnected along with the network interface 230 via a bus 220. Those of ordinary skill in the art and others will appreciate that the display 240 may not be necessary in all forms of computing devices and, accordingly, is an optional component. The memory 250 generally comprises random access memory (“RAM”), a read only memory (“ROM”) and a permanent mass storage device, such as a disk drive, flash RAM, or the like. The memory 250 stores the program code necessary for an image comparison routine 280 and a damage estimation routine 290. Additionally, the memory 250 stores an operating system 255 and a vehicle image database 270.

It will be appreciated that the software components may be loaded from a computer readable medium into memory 250 of the operating environment 200 using a drive mechanism (not shown) or network mechanism (not shown) associated with the computer readable medium, such as a floppy, tape, digital versatile disc (“DVD”)/CD-ROM drive, flash RAM, network interface card, or the like.

Although an exemplary operating environment 200 has been described that generally conforms to conventional general-purpose computing device, those of ordinary skill in the art will appreciate that a operating environment 200 may be any of a great number of devices capable of functioning as a device, server or operating environment that is within the spirit or scope of the embodiments described herein or can perform at least one function of the embodiments described herein.

In one exemplary embodiment, a user device 110 can configure or interact with the operating environment 200 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to operating environment 200 (e.g., displayed on the peer to peer display 240) may be made familiar and user friendly.

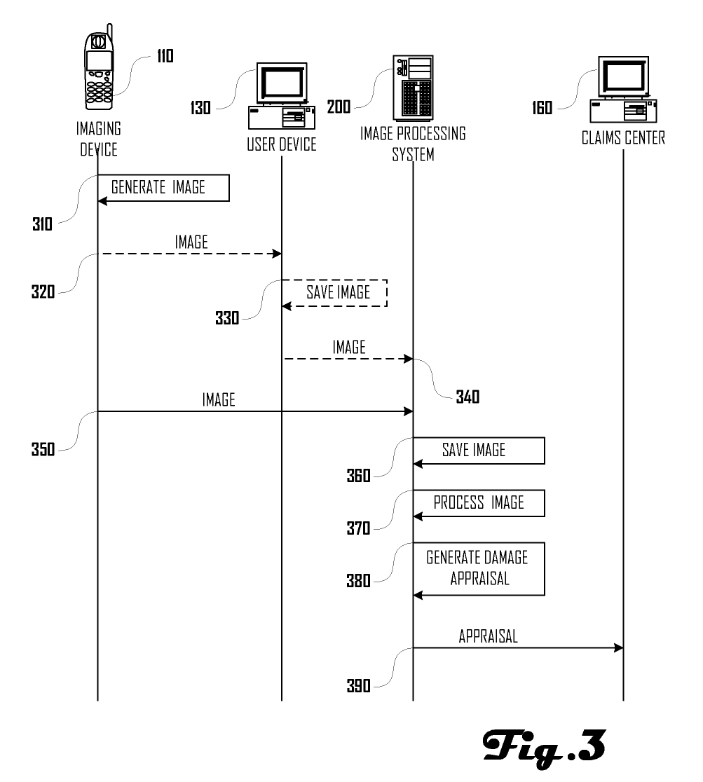

FIG. 3 is a diagram illustrating one exemplary series of communications between a digital imaging device 110, a user device 130, an image processing system 200 and a claims center 160 during insurance adjustment and damage appraisal through digital imaging. The communications begin with the imaging device 110 generating 310 an image. For example, a user can be involved in a vehicular accident wherein the user's vehicle is damaged, and the user can use a cellular telephone or other imaging device 110 to generate 310 an image of the user's damaged vehicle.

In an optional step, the imaging device 110 can send 320 the image to the user device 130, the user device 130 can save 330 the image, and the user device 130 can then send 340 the image to the image processing system 200. For example, in one embodiment, the imaging device 110 is a digital camera, and a user can send 320 the image to the user device 130, which in certain embodiments can be a computing system. After saving 330 the image, the image can be sent 340 to the image processing system 200 via the Internet, a network, e-mail, or the like. Alternatively, the imaging device 110 can generate 310 an image, and the image can be sent 350 to the image processing system 200 via the Internet, a network, a wireless network, e-mail, or the like.

In a further embodiment, a user can edit, modify, or configure a digital image on a computing system before sending 340 the digital image to the image processing system 200 by editing, configuration, or modification techniques including, but not limited to, cropping, changing the brightness, changing the contrast, changing the color saturation, changing the size of the image, adding or removing from the image, zooming in and out, rotating the image, or adding a grid system to the image, or the like. In one embodiment, the user can edit a digital image to conform or match a template. For example, a preferred submission of a digital image of a damaged vehicle may be required to closely conform to an image of an undamaged vehicle.

In one embodiment, the user can visit a website and upload one or more digital image to the image processing system 200. In a further embodiment, a user can edit, modify or configure a digital image on a website before sending 340 it to the image processing system 200 using editing, configuration, or modification techniques including, but not limited to, cropping, changing the brightness, changing the contrast, changing the color saturation, changing the size of the image, adding or removing from the image, zooming in and out, rotating the image, adding a grid system to the image, or the like. In one embodiment, the user can edit a digital image to conform or match a template. For example, a preferred submission of a digital image of a damaged vehicle may be required to closely conform to an image of an undamaged vehicle.

Accordingly, in one embodiment, a user can edit, modify or configure the image of a damaged vehicle on a website or through any other editing method or system, to make it closely match an image of an undamaged vehicle. This may include altering the relative size of the vehicle by zooming in or out on the image of the damaged vehicle, rotating the image of the damaged vehicle, changing the contrast, saturation or color of the image of a damaged vehicle to more closely match the contrast, saturation or color of an image of an undamaged vehicle, or cropping or removing pixels or segments of the image of the damaged vehicle so that only the image of the damaged vehicle itself is visible. In a further embodiment, a digital image is not edited, modified, configured or changed by the user device 130.

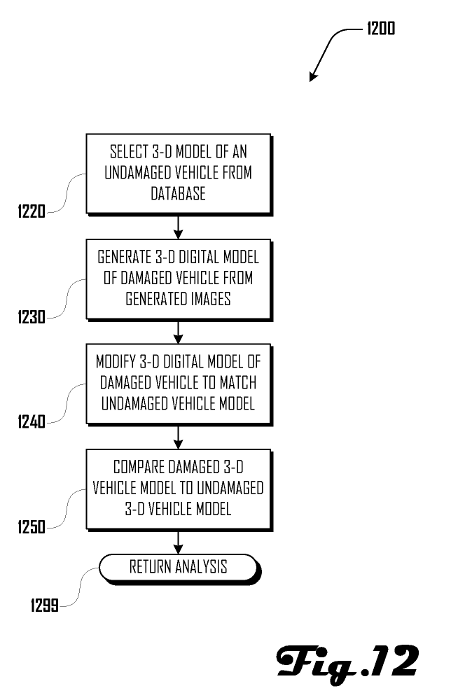

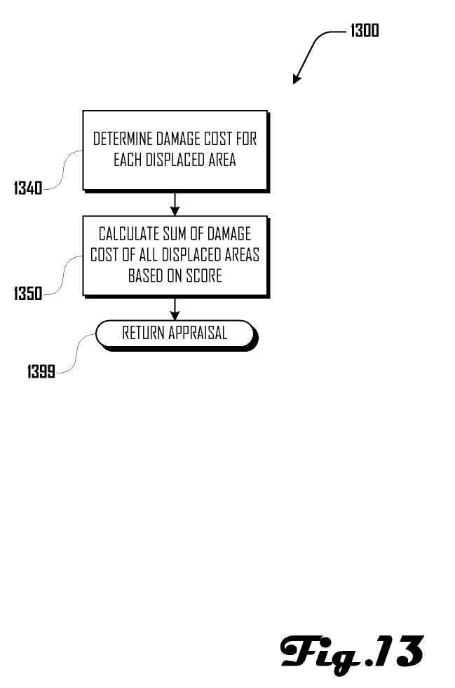

After the image is sent 350 to the image processing system 200, the image is saved 360. Next the image is processed 370 as described infra (See e.g., FIGS. 11 and 12), and a damage appraisal is generated 380 as described infra (See e.g., FIG. 13). Finally, the damage appraisal is sent 390 to the claims center 160, which can be achieved by any suitable method known in the art, including via facsimile, the Internet, e-mail, text message, mail, or the like. In one embodiment and insurance adjustment and/or damage appraisal can be generated by the image processing system 200 and sent 390 to the claims center 160.

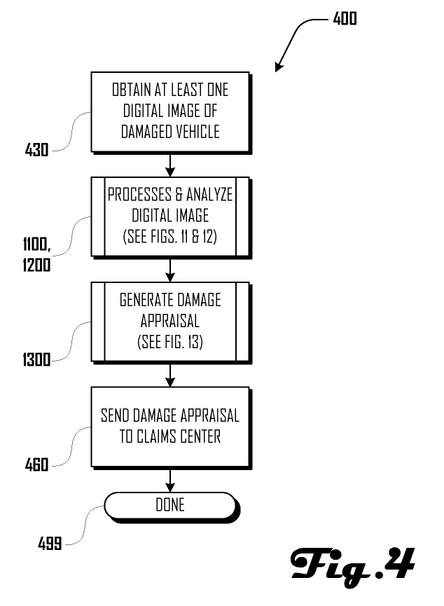

FIG. 4 is a block diagram of a routine for insurance adjustment and damage appraisal through digital imaging 400, in accordance with an embodiment of the invention. The method 400 begins at block 430, where at least one digital image of a damaged vehicle is obtained and then the routine 400 continues to subroutine 1100, 1200 where the digital image is processed and analyzed as described infra. (See e.g. FIG. 11 or 12) In one embodiment, the subroutine depicted in FIG. 11 or 12, or any variation thereon, can be employed to process and analyze the digital image. Returning to the routine, in subroutine 1300, a damage appraisal is generated as described infra (See e.g., FIG. 13), and then the damage appraisal is sent to a claims center 160 as depicted in block 460. The method is then done 499.

In one embodiment, when the image processing system 200 processes and analyzes the digital images, as in subroutine 1100, 1200, areas of positive and negative displacement are identified. In one embodiment, there can be a plurality of areas on a vehicle where positive or negative displacement can be identified. For example, broad areas such as the front-end, back-end, hood, drivers-side, passenger-side, roof, and the like can be identified as areas of displacement. Alternatively, more specific areas can be identified as areas of displacement, including driver-side front-end, driver-side rear-end, passenger-side front-end, passenger-side rear-end, passenger-side door, driver-side door, driver-side roof, passenger-side roof, and the like. Alternatively, any area of a vehicle, either specific or general, can be identified as an area where displacement can be present.

Then, a displacement score is calculated for each area where there is positive or negative displacement. In one embodiment, any method of calculating a displacement score can be used, including distance or length of displacement from one or more point, or area or volume of displacement. For example, if there is front-end damage that results in compaction of the front-end, displacement can be calculated by the difference in length of the front-end when comparing the image of the undamaged vehicle to the image of the damaged vehicle; alternatively, the difference in area or volume can be calculated given the difference in the image of the damaged and undamaged vehicles.

In another embodiment the driver of a first vehicle can collide with a second vehicle and create damage to one or both of the first and second vehicle. The first driver can alight from his vehicle and create a digital image of the damaged vehicle with an imaging device 110. For example, the first driver/user can use any mobile telephone with a digital camera 110 to capture or create a digital image of the damaged vehicle. The user/first driver, can create a digital image of the entire vehicle or a portion of the vehicle. After the user creates a digital image of the damaged vehicle with a cellular telephone 110, the digital image is sent and received 430 by the image processing system 200, which can be via a wireless module, Bluetooth®, multimedia message, instant message, e-mail, or by digital or analog cellular network, or the like.

In one embodiment a user can generate a non-digital image of a damaged vehicle with a film camera, and the user can develop the film through any method known in the art. The user can then scan the developed negatives or print an image from the developed negatives and scan the non-digital image into a digital image with any method or system known in the art, including, but not limited to a print scanner. Additionally, a user can scan negatives using a negative scanner and create a digital image.

Once a user has created a digital image, whether it originated from a digital or non-digital image, the image is then transferred to a user device 130 or an image processing system 200. The digital image can be transferred or communicated to the user device 130 though any method or system of transferring or communicating digital images, including, but not limited to e-mail, file transfer protocol, a cellular network, a telephone network, a satellite network, a local area network, a website, direct cable connection, the Internet, or the like

In one embodiment, the damage appraisal or insurance adjustment can be sent to one of a plurality of claims centers 160 or can be sent to one or more claim center 160. In a further embodiment, the image processing system 200 and one or more claims center 160 can be in the same, similar, or disparate locations. In a still further embodiment, the claims center 160 can comprise one or more insurance adjuster or one or more damage assessor.

In yet another embodiment, a plurality of images can be sent to the image processing system 200, each compared to one or more image of an undamaged vehicle and each comparison used to make at least one damage estimate. Images of the damaged vehicle can be in the same, different, or similar perspectives or there can be close-ups of certain areas of damage. A damage assessment can be made for the whole vehicle or for certain areas of the vehicle.

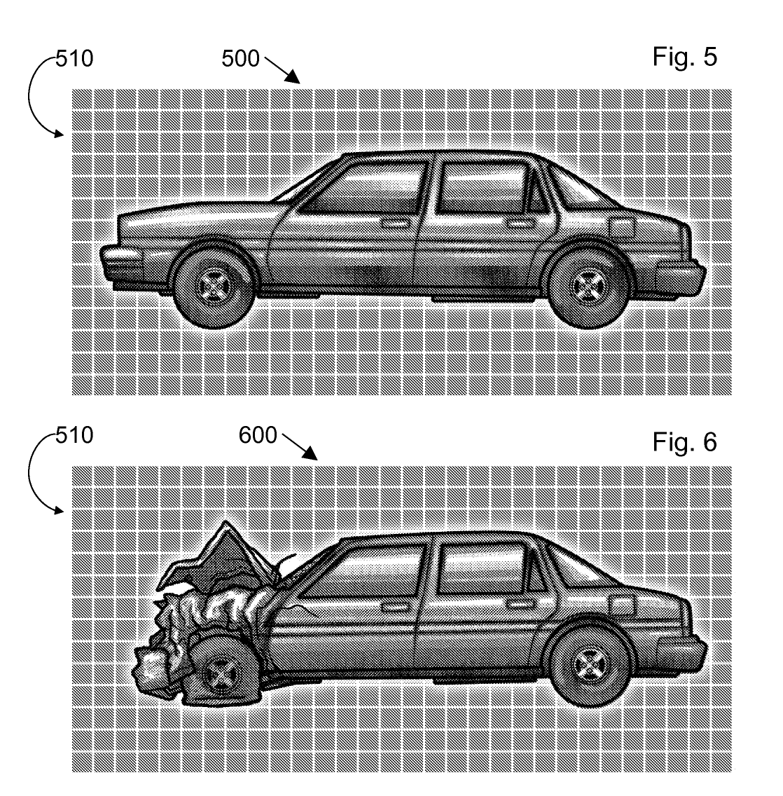

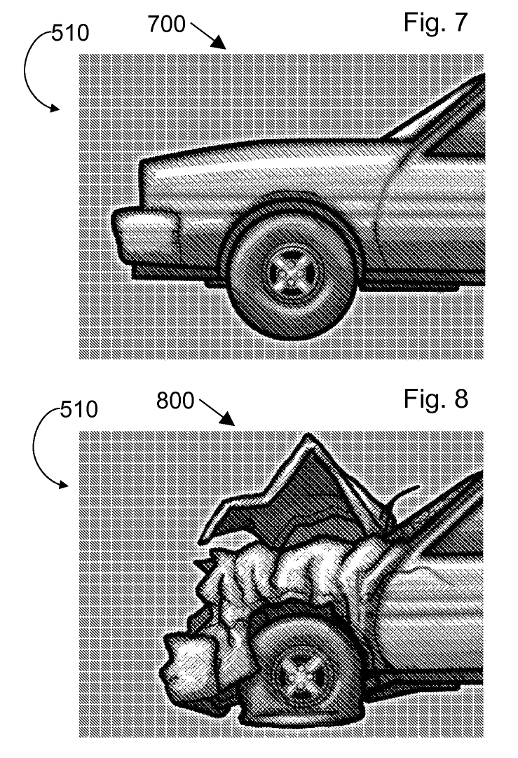

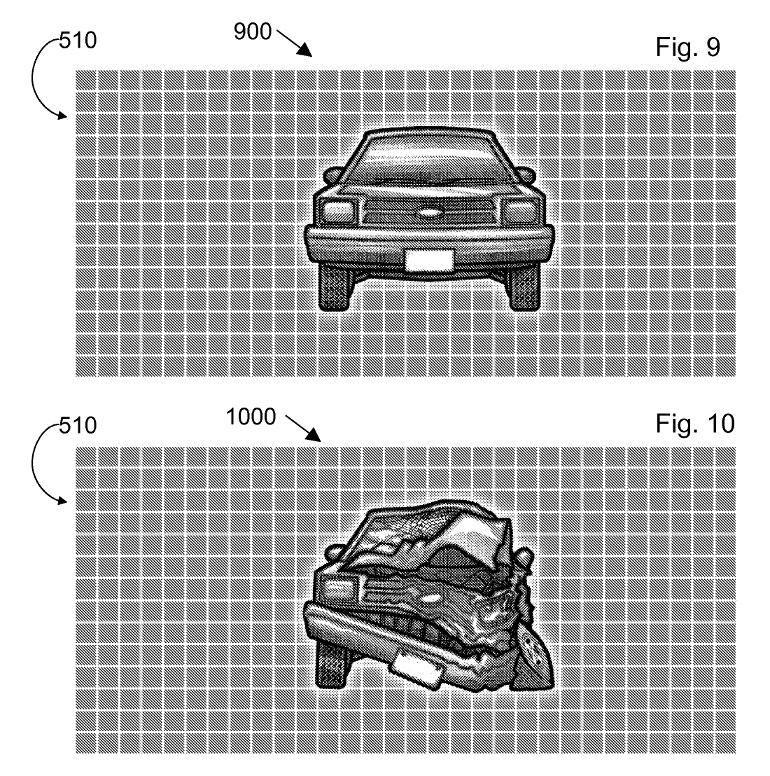

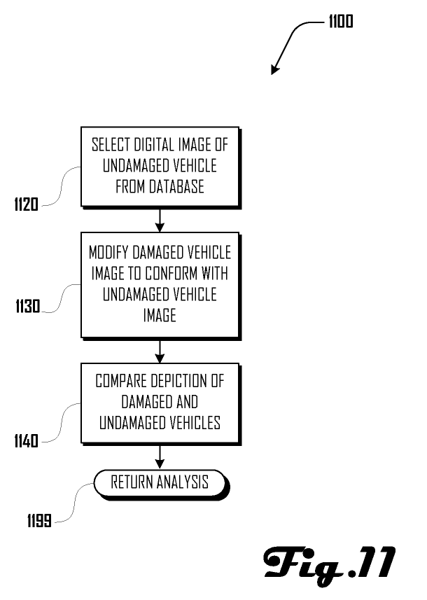

FIG. 5 is a side view image of an undamaged vehicle 500, which has been placed onto a grid system 510, in accordance with an embodiment of the invention and FIG. 6 is a side view image of a damaged vehicle 600, which has been placed onto a grid system 510, in accordance with an embodiment of the invention. FIG. 7 is a close-up side view image of an undamaged vehicle 700, which has been placed onto a grid system 510, in accordance with an embodiment of the invention and FIG. 8 is a close-up side view image of a damaged vehicle 800, which has been placed onto a grid system 510, in accordance with an embodiment of the invention. FIG. 9 is a front view image of an undamaged vehicle 900, which has been placed onto a grid system 510, in accordance with an embodiment of the invention and FIG. 10 is a front view image of a damaged vehicle 1000, which has been placed onto a grid system 510, in accordance with an embodiment of the invention.

In one embodiment of the invention, an image processing system can process the image of a damaged vehicle 600, 800, 1000 and create or generate a damage appraisal or insurance adjustment, by comparing the image of the damaged vehicle 600, 800, 1000 to the image of an undamaged vehicle 600, 800, 1000. The imaging processing system can comprise a database with one or more digital image that depicts an undamaged vehicle. The one or more digital image of an undamaged vehicle can depict any variation of vehicle, including but not limited to different makes, models, configurations, packages, colors of vehicles, or the like. The one or more digital image of an undamaged vehicle can be created by capturing an image of a vehicle that is representative of a plurality of vehicles that is identical or nearly identical, or the one or more digital image can be taken of a single vehicle that is representative of that single vehicle at a given time.

Although the one or more digital image can depict new cars, it can also depict cars with varying degrees of damage, age, modification, or the like. In another embodiment, the image can depict any vehicle, including, but not limited to a bicycle, tricycle, car, truck, motorcycle, moped, train, ship, aircraft or the like. In a further embodiment, the image can depict any object including a house, or living body, or an article of furniture, art, clothing, or the like. In a still further embodiment, the one or more image of a vehicle can be in any dimension, such as two or three dimensions, or in any perspective, including, but not limited to a front, rear, top, bottom, side view, or the like.

In one embodiment, the image can include a grid system 510 that is depicted or represented to be behind, within or in front of the vehicle. The grid system 510 can be of any size or shape and can be any type of grid system including, but not limited to a Cartesian grid, regular grid, rectilinear grid, curvilinear grid, an unstructured grid or the like. In a further embodiment the grid system 510 can be one or more dimensional. In a still further embodiment, a grid system can placed on an image or a computer program or other system can overlay a grid system onto an image.

In one embodiment, the image processing system can receive an image of a damaged vehicle 600, 800, 1000. The image processing system can configure the received image of a damaged vehicle 600, 800, 1000 so that it corresponds, matches, or aligns with an image of an undamaged vehicle 500, 700, 900 that matches, closely matches, or most closely matches the vehicle depicted in the image of a damaged vehicle 600, 800, 1000. For example, the image processing system 200 can alter the relative size of the damaged vehicle 600, 800, 1000 depicted, zoom in or out on the image of the damaged vehicle 600, 800, 1000, rotate the image of the damaged vehicle 600, 800, 1000, change the contrast, saturation or color of the image of a damaged vehicle 600, 800, 1000 to more closely match the contrast, saturation or color of an image of an undamaged vehicle 600, 800, 1000, or crop or remove pixels or segments of the image of the damaged vehicle 600, 800, 1000 so that only the image of the damaged vehicle itself is visible. In another embodiment, the image of an undamaged vehicle 500, 700, 900 can be similarly modified or configured.

In one embodiment, once the two images have been configured to have the same, similar, or relatively similar perspective, size, color, contrast, or saturation, a grid system, as described herein can be placed on or over the image. The imaging processing system can compare, analyze and process the two images by comparing the image of the damaged vehicle 600, 800, 1000 to the image of an undamaged vehicle 500, 700, 900.

For example, the front end of the vehicle depicted in FIGS. 6 and 8 has been crushed and does not occupy areas of the grid which are occupied by the undamaged front end of the vehicle as depicted in FIGS. 5 and 7. The image processing system can compare, analyze and process the change in length, height, width, area and volume caused by the damage to the vehicle by comparing grid system 510 of the image of the damaged vehicle 600, 800, to the image of an undamaged vehicle 500, 700.

Additionally, in another example, the hood of the vehicle depicted in FIGS. 6 and 8 has been crushed and deformed and therefore occupies areas of the grid which are not occupied by the undamaged front end of the vehicle as depicted in FIGS. 5 and 7. The image processing system 200 can compare, analyze and process the change in length, height, width, area and volume caused by the damage to the vehicle by comparing grid system 510 of the image of the damaged vehicle 600, 800, to the image of an undamaged vehicle 500, 700.

Moreover, in a further example, the rear end of the vehicle depicted in FIG. 6 has not been crushed or deformed and therefore occupies the same areas of the grid system 510 that are occupied by the undamaged front end of the vehicle as depicted in FIG. 5. The image processing system 200 can compare, analyze and process the lack of change in length, height, width, area and volume caused by the damage to the vehicle by comparing grid system 510 of the image of the damaged vehicle 600, to the image of an undamaged vehicle 500.

Similarly, in a still further example the hood of the vehicle depicted in FIG. 10 has been crushed and deformed and therefore occupies areas of the grid system 510 that are not occupied by the undamaged front end of the vehicle as depicted in FIG. 9. The image processing system 200 can compare, analyze and process the change in length, height, width, area and volume caused by the damage to the vehicle by comparing grid system 510 of the image of the damaged vehicle 1000, to the image of an undamaged vehicle 900. In one embodiment, the grid system 510 can be placed, depicted, or laid over the image of the vehicle to compare the image of the damaged vehicle 600, 800, 1000 to the image of an undamaged vehicle 500, 700, 900.

In yet another example, the right front end of the vehicle depicted in FIG. 10 has been crushed and does not occupy areas of the grid system 510 which are occupied by the undamaged right front end of the vehicle as depicted in FIG. 9. The image processing system 200 can compare, analyze and process the change in length, height, width, area and volume caused by the damage to the vehicle by comparing grid system 510 of the image of the damaged vehicle 1000, to the image of an undamaged vehicle 900.

In another example, the left front end of the vehicle depicted in FIG. 10 has not been crushed or deformed and therefore occupies the same areas of the grid system 510 that are occupied by the undamaged left front end of the vehicle as depicted in FIG. 9. The image processing system 200 can compare, analyze and process the lack of change in length, height, width, area and volume caused by the damage to the vehicle by comparing grid system 510 of the image of the damaged vehicle 1000, to the image of an undamaged vehicle 900.

In one embodiment of the present invention, the image processing system can create an insurance adjustment or damage appraisal for the damaged vehicle depicted in the image of the damaged vehicle 600, 800, 1000. As described herein, the image processing system 200 can compare, analyze and process the lack of change or change in length, height, width, area and volume caused by the damage to the vehicle by comparing grid system 510 of the image of the damaged vehicle 600, 800, 1000, to the image of an undamaged vehicle 500, 700, 900. The image processing system can use data of change in length, height, width area, or volume of one or more portion of the vehicle to determine the quantity, extent, and severity of the damage to the vehicle depicted in the image of the damaged vehicle 600, 800, 1000.

For example, if the image processing system determines that the front end of a damaged vehicle has been compressed by one (1) foot, the image processing system can use this measurement of displacement to estimate or approximate the cost of damage caused by such a compression. The estimation of the cost of damage to the vehicle can be different if the front end was compressed by 0.5, 1, 1.5, or 2 feet and the cost of the damage need not share a liner relationship, proportional relationship or correlation to the distance compressed. Such an estimate can be based on data compiled for the cost of damage for the same or similar vehicle at different points of compression. In another embodiment, the estimation or approximation of the cost of damage can be based on the cost of repairing or replacing parts located in compressed areas of the vehicle.

Additionally, for certain areas of the vehicle, the presence of matter or vehicle parts in an area of the grid system 510 can indicate damage to the vehicle. For example, the hood of a vehicle can be crushed or deformed such that it extends above the normal plane of the front end of the vehicle. The image processing system can determine the damage to the hood or other parts of the vehicle by calculating the change in length, height, width, area, or volume of the hood of the vehicle to determine the quantity, extent, and severity of the damage to the hood or other part of the vehicle depicted in the image of the damaged vehicle 600, 800, 1000.

FIG. 11 is a flow diagram illustrating a subroutine for estimating damage to a vehicle 1100, in accordance with an embodiment of the invention. The routine begins at block 1120, where a digital image of an undamaged vehicle is selected from a database. In one embodiment the database is an element of an image processing system 200, and the database comprises a plurality of images of undamaged vehicles. The images of vehicles in the database can be of different makes and models of vehicle and there can be a plurality of perspectives of each make and model of vehicle.

Selection of an image of an undamaged vehicle can be based on a plurality of criteria, including selection of an image that depicts the same or similar make and model as depicted in the image of the damaged vehicle; selection of an image that is in the same or a similar perspective as the image of the damaged vehicle, or the like.

Returning to the subroutine, in block 1130, the image of the damage vehicle is modified such that the depiction of the damaged vehicle is most similar to the selected depiction of the undamaged vehicle. The image of the damaged vehicle can be modified in any way as described herein or that is known in the art such that an optimal comparison of the two images can be made. In one embodiment, the undamaged vehicle image can be modified, or both the undamaged and damaged vehicle image can be modified.

Next, in block 1140 the image of the damaged vehicle and undamaged vehicle are compared; more specifically, the depictions of the damaged vehicle and undamaged vehicle are compared. In one embodiment, calculations can be made to determine the amount of distortion to certain areas of the vehicle due to damage. Both positive and negative distortion can be calculated. As used herein, the term ‘negative distortion’ refers to a compaction, loss of volume, or shortening of length as a result of damage to a vehicle. As used herein, the term ‘positive distortion’ refers to an expansion, gain of volume, or and extension of length as a result of damage to a vehicle. Then the subroutine returns the analysis of the images 1199.

In one embodiment, the estimation can be based on positive or negative distortion where greater degrees of distortion may indicate greater damage and therefore greater cost to repair. Cost associated with a certain degree of distortion can vary depending on the make and model of vehicle, vehicle parts located in the area of distortion, vehicle parts creating the area of distortion, and the like.

FIG. 12 is a flow diagram illustrating a subroutine for estimating damage to a vehicle 1200, in accordance with a further embodiment of the invention. The routine begins in block 1220, where a three dimensional (3-D) digital model of an undamaged vehicle is selected from a database that comprises a plurality of 3-D digital models of vehicles. The model can be selected with the purpose of being similar to or of the same make and model of the vehicle depicted in the generated at least one image of a damaged vehicle.

Then, in block 1230, a 3-D digital model is generated from the one or more generated image of a damaged vehicle. 3-D rendering and drawing programs are well known in the art, for example programs such as AudoCAD® or Audodesk Inventor® (Autodesk, Inc.®, Mill Valley, Calif.), and the like, can be used.

Next, in block 1240, the 3-D model of the damaged vehicle is modified so as to match the relative size and model properties of the selected 3-D model of the undamaged vehicle such that an optimal comparison of the two models can be made. This can be done through methods described herein or any other method known in the art. In one embodiment, the 3-D model of the undamaged vehicle or the 3-D model of both the damaged and undamaged vehicle can be modified.

Then, in block 1250 the 3-D model of the damaged vehicle is compared to the 3-D model of the undamaged vehicle. In one embodiment, calculations can be made to determine the amount of distortion to certain areas of the vehicle due to damage. Both positive and negative distortion can be calculated in two or three dimensions. Then, the subroutine returns the analysis of the images 1299.

In one embodiment, the estimation can be based on positive or negative distortion of volumes or length where greater degrees of distortion may indicate greater damage and therefore greater cost to repair. Cost associated with a certain degree of distortion can vary depending on the make and model of vehicle, vehicle parts located in the area of distortion, vehicle parts creating the area of distortion, and the like.

In a still further embodiment, a three dimensional rendering of an undamaged vehicle can be manipulated and/or configured such that damage depicted in one or more image of a damaged vehicle can be modeled. Further, manipulation and/or modeling of damage or deformation can provide real-time estimation of damage given the manipulations or deformations introduced to the rendering of the undamaged three dimensional vehicle. For example, as the three dimensional model is deformed, damage can be estimated given the degree of deformation and the specific vehicle parts that are present in the deformed area. In yet another embodiment, a range of possible damage estimates can be generated.

FIG. 13 is a flow diagram illustrating a subroutine for calculating a damage estimate 1300, in accordance with a still further embodiment of the invention. The subroutine 1300 begins in block 1340, where the damage cost for each displaced area is determined. In one embodiment, cost of displacement can have a linear, exponential, or variable relationship with positive or negative displacement score. Displacement score can be based on predetermined estimates or calculations of damage for various displacement scores in a given vehicle area, historical data from damage costs of damaged vehicles of the same make and model, and the like. Finally, in block 1350, the sum of the damage cost of all displaced areas based on score is calculated, and then the method is done 1399.

In one embodiment, a damage estimate can be based on variables in addition to positive or negative displacement. For example, where there is damage such as a cracked windshield, which may not be identified as having displacement, the image processing system 200 can be configured to identify such damage. In a further embodiment, the image processing system 200 can identify damage to a vehicle in one or more areas based on differences in the image of a damaged vehicle and an image of an undamaged vehicle, where such identification is not made based on displacement.

In another embodiment, damage estimations based on displacement scores or other variables can account and/or estimate damage to vehicle parts within a damaged vehicle. Furthermore, in another embodiment, damage estimations can take into account the make and model of a given vehicle and the cost associated with the given make and/or model of the vehicle. For example, when analyzing a Ferrari® as compared to a Honda Accord®, damage estimations would account for the higher price of parts for the Ferrari® as compared to the Honda Accord.®

Although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. Therefore, it is manifested and intended that the invention be limited only by the claims and the equivalents thereof. While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined by reference to the claims that follow.

1. A computer implemented method for providing an object damage appraisal through digital imaging, the method comprising:
obtaining a first digital damaged object image depicting a damaged object;
comparing the first digital damaged object image to a first digital undamaged object image, depicting an undamaged object, from an object database; and,
generating a damage appraisal based on the difference between the first digital damaged object image and the first digital undamaged object image.

2. The method of claim 1, wherein the object is a vehicle.

3. The method of claim 2, wherein the first digital damaged vehicle image is modified such that said depicted damaged vehicle is of corresponding size to said undamaged vehicle depicted in the first digital undamaged vehicle image.

4. The method of claim 3, wherein the first digital damaged vehicle image is modified such the image properties of the first digital damaged vehicle image correspond to the image properties of the first digital undamaged vehicle image.

5. The method of claim 2, the method further comprising:
obtaining a second digital damaged vehicle image depicting said damaged vehicle, the second digital damaged vehicle image being a different perspective than said first digital damaged vehicle image; and
comparing the second digital damaged vehicle image to a second digital undamaged vehicle image from a vehicle database,
wherein said damage appraisal is further based on the difference between the second digital damaged vehicle image and the second digital undamaged vehicle image.

6. The method of claim 5, wherein said first and second digital undamaged vehicle image are a three dimensional rendering of an undamaged vehicle.

7. The method of claim 6, wherein one or more digital damaged vehicle image is used to generate a three dimensional rendering of the damaged vehicle depicted in the one or more digital image; and
wherein the three dimensional rendering of the damaged vehicle depicted in the one or more digital image is compared to said three dimensional rendering of an undamaged vehicle.

8. The method of claim 7, further comprising the step of generating a claim adjustment based on the differences between the first digital damaged vehicle image and the first digital undamaged vehicle image.

9. The method of claim 4, wherein a grid system is used when comparing said first digital damaged vehicle image and said first digital undamaged vehicle image.

10. The method of claim 4, wherein said depicted first damaged vehicle and said depicted first undamaged vehicle image are in the same perspective.

11. The method of claim 5, wherein said depicted first damaged vehicle and said depicted first undamaged vehicle image are in the same perspective; and,
said depicted second damaged vehicle and said depicted second undamaged vehicle image are in the same perspective.

12. The method of claim 10, wherein said depicted first damaged vehicle and said depicted first undamaged vehicle image are the same make and model of vehicle.

13. The method of claim 11, wherein said depicted first damaged vehicle and said depicted first undamaged vehicle image are the same make and model of vehicle; and,
said depicted second damaged vehicle and said depicted second undamaged vehicle image are the same make and model of vehicle.

14. The method of claim 13, wherein said damage appraisal is further based on at least one of:
a calculation of negative deformation in one or more area of the vehicle;
a calculation of positive deformation in one or more area of the vehicle; or
a calculation of positive and negative volume in one or more area of the vehicle.

15. The method of claim 14, wherein said amount of positive and negative deformation is calculated using a grid system.

16. A computing device having a processor and a memory with computer executable instructions which, when executed by said processor, perform the method of claim 1.

17. A computer readable medium having executable instructions, which when executed perform the method of claim 1.

18. A computing device, the device configured to provide an object damage appraisal through digital imaging, the device comprising:
a means for obtaining a first digital damaged object image depicting a damaged object;
a means for comparing the first digital damaged object image to a first digital undamaged object image, depicting an undamaged object, from an object database; and,
a means for generating a damage appraisal based on the difference between the first digital damaged object image and the first digital undamaged object image.

19. The computing device of claim 18, wherein the object is a vehicle.

20. The computing device of claim 19, wherein said damage appraisal is further based on at least one of:
a calculation of negative deformation in one or more area of the vehicle;
a calculation of positive deformation in one or more area of the vehicle; or
a calculation of positive and negative volume in one or more area of the vehicle.
